(19) United States
(12) Patent Application Publication
(10) Pub. No.: US 2011/0277253 A1
(43) Pub. Date: Nov. 17, 2011

(54) Gate hugger - platform and loading ramp system

(76) Inventor: Harry James Billow, Columbia Falls, MT (US)

(21) Appl. No.: 12/800,471

(22) Filed: May 17, 2010

(51) Int. Cl. B65G 69/30

(52) U.S. Cl. 14/71.1

(57) ABSTRACT

1. A securing platform comprising:
a reinforced rectangular frame and cover plate; the longest length runs parallel and rests upon the top of an open tailgate of a pickup,
an eyebolt located 6 inches in from both ends of front face of platform; with attached securing chains to be anchored to tiedowns at rear of truck bed,
a metal plate and a rubber pad are bolted 1⅝ inches in from both ends to the rear face of platform to hang 90 degrees below the horizontal plane of tailgate to function as stop from forward motion; a securing chain attached to the opposite end of each metal plate is anchored to the bumper of a pickup truck,
steel tubing is welded to the rear face of the platform to form outside portions of a hinge and configured to attach ramps at three locations;
   2. Loading ramps comprising:
1¼ inch steel square channel on the end; 1½ inch angle steel for six and eight foot sides, with 1 foot cross members spaced 10 inches apart,
wherein a steel tube is centered and welded to the end of a ramp to form the center portion of a hinge connection,
wherein loading ramps are attached to the platform by inserting a solid 1/4 inch steel rod through the three portions of steel tubing; therefore securing the ramp and allowing the ramp to pivot at various degrees from the plain of the tailgate.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Experience loading and unloading motorbikes, ATVs, etc. has proven to be an unsafe practice with many types of loading ramps. Accidents occur when the loading ramps are not secured to the vehicle allowing them to give way during the loading process. Most loading ramps rely on the weight of the motorbike plus the pressure against the tailgate to secure the ramp for the loading or unloading process. The shifting of weight in maneuvering the motorbike, shifting of weight due to uneven surfaces at the base of the ramp, and environmental conditions develop problems at the anchor points of loading ramps. This problem is greatly enhanced when the anchor point at the tailgate/ramp location is a metal surface placed against another poor gripping surface.

Securing loading ramps to the conventional tailgate of a pickup truck, without making alterations to the tailgate, has lead to the development of the Gate Hugger.

### BRIEF SUMMARY OF THE INVENTION

To manufacture an anchoring source for ramps; therefore to establish a higher degree for safety in loading motorbikes, ATVs, etc., the design of the Gate Hugger Platform is developed.

A sturdy frame constructed of 1¼ steel channel and steel cover plate is anchored to the outside edge of a pickup open tailgate. Anchoring is applied to the front of the platform by chains fastened to the tiedowns found at the rear of the pickup bed. Anchoring is applied to the rear of the platform by chains fastened to the bumper of the pickup. Locking pressure is applied to all anchoring chains by applying a chain binder to one of the front chain locations.

Loading ramps are secured to the Gate Hugger Platform by the interlocking of three lengths of steel tubing. Two 3 inch lengths are welded to the rear of the platform to form side portions of a hinge connection at three determined locations for ramps. One 6 inch length of steel tubing is welded to the end of a loading ramp to form the center of a hinge connection. A 16 inch length of solid steel rod is inserted into the interior of the three tubes to form a secure hinge connection and allows the ramp to move at angles (plus and minus) to the plane of the tailgate.

The secure anchoring of the Gate Hugger platform to the pickup tailgate therefore establishing a secure anchoring location for one end of a loading ramp will greatly improve the overall safety for the loading process of motorbikes, ATVs, etc. Problems of shifting weight or hitting the ramp with a wheel during maneuvering, therefore allowing the ramp to be moved from its proper location, will be eliminated.

Reducing the slope of a loading ramp decreases the difficulty in the loading process of motorbikes, ATVs, etc. Many loading ramp designs allow little variance between the plane of a pickup and the plane of the loading surface. The assumption that a motorbike will be driven onto the pickup or perhaps loaded with the use of a winch may have determined the design, but driving a motorbike unto a pickup, for the purpose of loading, is less of a safety decision then loading manually. To great of a variance when using these ramps creates less surface area for contact at the tailgate/ramp location therefore lessening overall safety. The Gate Hugger tailgate/ramp hinge allows variance for the angle of ramps and facilitates loading of a motorbike even at angles downhill off of a bank while providing for the security of the ramp connection.

### BRIEF DESCRIPTION OF THE SEVERAL VIEWS OF THE DRAWING

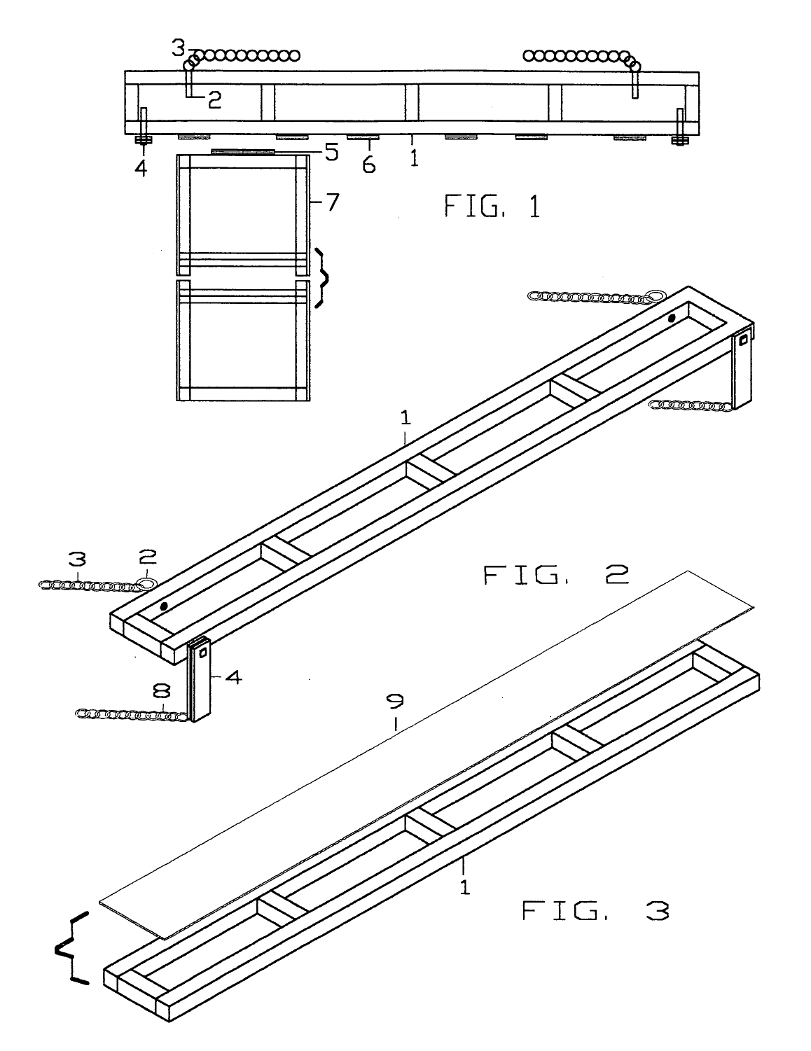

A top view of the Gate Hugger platform and ramp is shown on drawing page lof 1 and FIG. 1. The top view is oriented with the top of the drawing page facing the front of a pickup truck. Reference number
1. Platform frame
2. Eye bolt
3. Securing chains (fastened to truck tiedowns)
4. Stop (metal plate and rubber pad, same size)
5. Center of hinge, six inch length, of loading ramp
6. Side of hinge, three inch length, rear of platform
7. Ramp (no particular length)

A rear view of the Gate Hugger platform is shown on drawing page 1 of 1 and FIG. 2. The rear view is oriented with the top of the drawing page facing the front of a pickup truck.

Reference number
1. Platform frame
2. Eye bolt
3. Securing chains (fastened to truck tiedowns)
4. Stop
8. Securing chains (fastened to truck bumper)

An exploded view of the Gate Hugger platform is shown on drawing page 1 of 1 and FIG. 3. The exploded view is oriented with the top of the drawing page facing the front of a pickup truck. Reference number
1. Platform frame
9. Cover plate

### DETAILED DESCRIPTION OF THE INVENTION

The Gate Hugger platform and ramp system is developed to improve safety in the loading and unloading process of motorbikes, ATVs, etc. It is a new concept allowing for the securing of a loading ramp to the conventional tailgate of a pickup without making alterations to or damage to the tailgate. The Gate Hugger also improves the versatility of loading ramps by allowing safe and secure use of ramps at angles (plus and minus) to the plane of the tailgate unlike many ramps produced to this date.

The frame of the Gate Hugger platform is constructed of 1¼ steel channel. Two 54 inch lengths of channel are welded to 3½ inch lengths at the ends, center, and two locations half the distance from center to ends to form a rectangle 54 inches by 6 inches. A cover plate of ⅛ inch steel plate of the same dimension, 54 inches by 6 inches is welded to one (top) side of the frame.

Located 6 inches in from both ends at the front of the platform are two ½ inch eyebolts. The frame is drilled and the eye bolt is placed with the threads and fastening nuts on the inside of the frame. Chains are extended from each eye bolt and are fastened to the tie downs located at the rear of the pickup bed. A chain binder is applied to either of these chains and the tension is used to center and lock the platform securely into place.

Located 1⅝ inches in from both ends at the rear of the platform are the two stops. The frame is drilled and a bolt is passed through the top of a 2×5×¼ inch metal plate and a rubber pad of the same measurement. The head of the bolt remains to the outside of the frame and the threads and fastening nuts are on the inside of the frame. The metal plate and rubber pad hang 90 degrees below the horizontal plane of the tailgate and function as a stop to prevent the platform from forward movement. The rubber pad is ½ inch in thickness and protects the finish of the trucks tailgate. The metal plate provides strength for the stop. Chains are extended from a hole drilled at the bottom of each stop. These securing chains are fastened to the truck bumper and are used to keep the platform and the tailgate from moving upwards. The two chains extended from the front of the platform and the two extending from the rear of the platform collectively lock down the Gate Hugger Platform to the tailgate.

Loading ramps are secured to the Gate Hugger Platform by the interlocking of three lengths of steel tubing. Two 3 inch lengths are welded to the rear of the platform at three determined ramp locations. One 6 inch length of steel tubing is welded to the end of a loading ramp. A 16 inch length of solid steel rod is inserted into the interior of the three tubes to form a secure hinge connection and allows the ramp to move at angles (plus and minus) to the plane of the tailgate.

Loading ramps are constructed of ½ inch steel angle. Ramps will be made in six foot and eight foot lengths and 1 foot in width. The 1 foot cross members of the ramps will be spaced 9 to 10 inches apart along the length of the ramp.

1. The Gate Hugger Platform frame assembly comprising: two side rails fortifying the length of the frame, cross members of equal length attaching the side rails at opposite ends, additional cross members attaching proportionally along the frame length, and a rectangular plate attaching to the top face of said frame.

2. The Gate Hugger Platform, centered on the outer edge of the pickup open tailgate, is secured by stops attached to opposite ends on the rear face of said platform.

3. The Gate Hugger Platform of claim 2 is further secured with chains attached and extended from said stops; wherein said chains are attached with hooks to the adjacent ends of the pickup bumper.

4. The Gate Hugger Platform of claim 2 is further secured with chains attached and extended from opposite ends on the front face of said platform; wherein said chains are attached with hooks to the adjacent tie downs at the rear of the pickup bed.

5. The Gate Hugger Platform of claim 2 is bound from movement in all directions by a chain binder applied to one forward chain.

6. The Gate Hugger Platform of claim 2 defines a central ramp location by mounting a pair of tubular channels on the rear face of said platform; wherein each of the said channels function as an outside section of a hinge joint arranged for center loading of a motorbike.

7. The Gate Hugger Platform of claim 2 defines two lateral ramp locations by mounting a pair of tubular channels at said locations on the rear face of said platform; wherein each of the said channels function as an outside section of a hinge joint arranged for dual ramp loading of a four wheeled ATV.

8. The ramp assembly comprising a pair of right angle rails fortifying the length of the ramp; one leg of said rail forming the side face of the ramp, and the opposite leg of said rail forming a portion of the top face of the ramp.

9. The ramp assembly of claim 8 further comprising square channel cross members of equal length attached at each end of said ramp; a tubular channel attached to one said member is arranged for the center section of a hinge joint.

10. The ramp assembly of claim 8 further comprising right angle cross members, arranged to cradle wheel curvature, function to control the rolling speed of a motorbike during the loading process.

11. The right angle cross members of claim 10 are attached with the open legs of said members oriented toward the top of surface of the ramp; wherein the ridges and valleys formed by said arrangement enhance tire traction during the loading process.

12. The Gate Hugger Platform and ramp(s) interlock one another with a rod inserted into a three piece hinge comprising: (a) a pair of tubular channels attached to the rear face of the Gate Hugger platform at three ramp locations, and (b) one tubular channel attached to the end of the ramp(s) connected at said ramp locations.

13. The hinge joint of claim 12 eliminates slippage between ramp(s) and pickup bed to insure safety and enhance stability of the entire ramp(s).

14. The hinge joint of claim 12 provides pivot action for each ramp to increase versatility when loading a motorbike onto a pickup from a level above or below the level of the pickup bed.
